(19) United States
(12) Patent Application Publication
(10) Pub. No.: US 2015/0002642 A1
(43) Pub. Date: Jan. 1, 2015

(54) VEHICLE VISIBILITY IMPROVEMENT SYSTEM

(71) Applicant: RWD Consulting, LLC, Bend, OR (US)

(72) Inventor: Roger Wallace Dressler, Bend, OR (US)

(21) Appl. No.: 14/319,106

(22) Filed: Jun. 30, 2014

Related U.S. Application Data
(60) Provisional application No. 61/841,757, filed on Jul. 1, 2013.

(51) Int. Cl. H04N 13/04; B60R 11/04

(52) U.S. Cl. CPC H04N 13/0404; B60R 11/04
USPC 348/51

(57) ABSTRACT

A multi-view display on a pillar in a vehicle can simultaneously project several different image perspectives across a defined area, with each perspective becoming visible as a driver shifts his or her position. The different perspectives may be created using a multi-view lens. As the driver moves fore and aft or side to side, the driver's viewing angle relative to the lens changes, enabling the appropriate image to be seen. This arrangement can eliminate or reduce any need for active head or eye tracking and can assure or attempt to ensure the appropriate exterior image is available independent of the driver's viewing angle relative to the display.

### RELATED APPLICATION

This application claims priority under 35 U.S.C. §119(e) as a nonprovisional application of U.S. Provisional Application No. 61/841,757, filed Jul. 1, 2013 titled “Driver Visibility Improvement System,” the disclosure of which is hereby incorporated by reference in its entirety.

### BACKGROUND

Motor vehicles incorporate pillar structures to support the roof and windshield. Some of these pillars, called A-pillars, partially block the driver's view, creating a safety hazard. FIG. 1 shows a portion of the interior 100 of a motor vehicle, with a driver's view obstructed due to the A-pillar 110 and door frame 120. FIG. 2 shows an external view 200 of the vehicle 201, with the A-pillar 110 (and door frame) obstructing approximately 7° of a driver's 230 view outside the vehicle 201. The amount of view obstructed depends on the width of the A-pillar and the distance of the A-pillar from the driver.

### SUMMARY

For purposes of summarizing the disclosure, certain aspects, advantages and novel features of several embodiments are described herein. It is to be understood that not necessarily all such advantages can be achieved in accordance with any particular embodiment of the embodiments disclosed herein. Thus, the embodiments disclosed herein can be embodied or carried out in a manner that achieves or optimizes one advantage or group of advantages as taught herein without necessarily achieving other advantages as may be taught or suggested herein.

In certain embodiments, a system for increasing visibility in a vehicle can include a camera that can obtain video of a scene exterior to a vehicle, which may be at least partially blocked by a pillar in the vehicle so as to create a blind spot in the vehicle. The system may also include a multi-view display that can be affixed to an interior portion of the vehicle pillar. The multi-view display can include a display screen and a multi-view lens disposed on the display screen. The system may also include a hardware processor in communication with the camera and with the multi-view display. The hardware processor can implement an image processing module that can receive the video of the scene exterior to the vehicle, where the video includes a plurality of video frames; partition each of the video frames into a plurality of overlapping images; interleave the overlapping images to produce an interleaved image frame corresponding to each of the video frames; and provide the interleaved image frame corresponding to each of the video frames to the multi-view display. The multi-view display can receive the interleaved image frame from the hardware processor and output the interleaved image frame such that a different one of the overlapping images is presented to an occupant of the vehicle based on a position of the vehicle occupant with respect to the multi-view display.

The system of the preceding paragraph may be implemented together with any combination of one or more of the following features: the multi-view lens can include a lenticular lens; the multi-view lens can include a parallax barrier; the multi-view lens can include a fly's lens array; and/or the hardware processor can also perform one or more of the following image enhancements on the video frames: bowing, horizontal stretching, and/or vertical stretching.

In certain embodiments, an apparatus for increasing visibility in a vehicle can include a hardware processor that can receive a video of a scene exterior to a vehicle from a camera, partition the video into a plurality of overlapping images, and interleave the overlapping images to produce interleaved images. The apparatus may also include a multi-view display that can receive the interleaved images from the hardware processor and output each of the interleaved images such that a different one of the interleaved images is presented to an occupant of the vehicle based on a position of the vehicle occupant with respect to the multi-view display.

The apparatus of the preceding paragraph may be implemented together with any combination of one or more of the following features: the multi-view lens can include a lenticular lens; the multi-view lens can include a compound lenticular lens and Fresnel lens; the multi-view lens can include a microlens array; the multi-view display and the hardware processor can be integrated in a single unit; and/or the apparatus may also include a data storage device that can store images of the multi-view video for subsequent provision to an insurance entity.

In certain embodiments, a method of increasing visibility in a vehicle can include receiving, with a hardware processor in a vehicle, a video of a scene external to the vehicle. The scene maybe obstructed at least partially from view from an interior of the vehicle by a pillar of the vehicle. The method may also include generating a multi-view video from the video of the scene with the hardware processor. The multi-view video can include interleaved images of the scene. Further, the method may include electronically providing the multi-view video from the hardware processor to a multi-view display affixed to the pillar in the interior of the vehicle, enabling the multi-view display to present a different one of the interleaved images of the scene to the driver depending on a viewing angle of the driver with respect to the multi-view display.

The method of the preceding paragraph may be implemented together with any combination of one or more of the following features: generating the multi-view video can include generating horizontally-interleaved images; generating the multi-view video can include generating vertically-interleaved images; generating the multi-view video can include generating both horizontally-interleaved and vertically-interleaved images; generating the multi-view video can include one or both of stretching the video horizontally or stretching the video vertically; generating the multi-view video can include bowing the video; the method may further include providing one or more viewer interface controls that can provide functionality for a viewer to adjust a crop of the multi-view video; the one or more viewer interface controls can also provide functionality for the viewer to adjust a bowing parameter of the multi-view video; and/or the method may further include storing images from the multi-view video for subsequent provision to an insurance entity.

In certain embodiments, a method of increasing visibility in a vehicle can include obtaining a multi-view video of a scene external to a vehicle. The scene may be obstructed at least partially from view from an interior of the vehicle by a pillar of the vehicle. The multi-view video can include interleaved images of the scene. The method may also include electronically outputting the multi-view video on a multi-view display affixed to the pillar in the interior of the vehicle so as to present a different one of the interleaved images of the scene to an occupant of the vehicle depending on a position of the vehicle occupant with respect to the multi-view display.

The method of the preceding paragraph may be implemented together with any combination of one or more of the following features: the obtaining and electronically outputting can be performed by a hardware processor separate from the multi-view display; and/or the obtaining and electronically outputting can be performed by the multi-view display.

### BRIEF DESCRIPTION OF THE DRAWINGS

Throughout the drawings, reference numbers are re-used to indicate correspondence between referenced elements. The drawings are provided to illustrate embodiments of the features described herein and not to limit the scope thereof.

FIG. 1 depicts a portion of an interior of a motor vehicle with a driver's view obstructed due to an A-pillar.

FIG. 2 depicts an external view of the vehicle of FIG. 1 showing the obstruction of the driver's view by the A-pillar.

FIG. 3 depicts an example vehicle with an external camera for providing a view through a pillar of the vehicle.

FIG. 4 depicts a portion of an interior of the vehicle of FIG. 3 including a multi-view display for providing the view through a pillar of the vehicle.

FIG. 5 depicts example ranges of different views on the multi-view display of FIG. 4 based on driver position.

FIG. 6 depicts an example process of obtaining multiple views for a multi-view display based on a camera image.

FIG. 7 depicts an example close-up perspective view of lenticules of an example multi-view display.

FIG. 8A depicts example side views of lenticules with different angles.

FIG. 8B depicts an example elevation view of a multi-view display.

FIG. 9A depicts an example vehicle with a multi-view display that provides views for both the driver and passenger of the vehicle.

FIG. 9B depicts a vehicle with example external cameras on multiple locations of the vehicle.

FIGS. 10A and 10B depict two example systems for providing multi-view display images in a vehicle.

FIG. 11 depicts an embodiment of a multi-view image display process.

FIG. 12A depicts an example side view of a vehicle with an example multi-view display.

FIG. 12B depicts an example top view of a driver and a multi-view display.

FIG. 13 depicts an example flat multi-view display with a curved image displayed thereon.

FIG. 14 depicts an example curved multi-view display with a flat image displayed thereon.

FIGS. 15A through 15D depict additional example views of lenses of a multi-view display.

FIG. 16 depicts another embodiment of a multi-view image display process.

FIG. 17 depicts an example multi-view display viewer interface.

### DETAILED DESCRIPTION

### I. Introduction

A driver visibility improvement system for a vehicle can include a display screen mounted on the surface of a structural pillar that would otherwise impair the vision of the driver. The screen can present an image derived from a camera mounted in the vicinity of the pillar, such as on the external surface of the pillar or inside the vehicle viewing through the windshield, aimed so as to cover at least a portion of the area blocked from the driver's view. The camera's image may be cropped and sized to correspond with the area of the scene blocked from view using a processor, thus creating the illusion to the driver that the obstruction is transparent or that the severity of the obstruction has been substantially reduced.

If the driver's position changes, as may happen when the seat is moved forward or backward, or the driver leans to one side or the other, the pillar and the attached display screen might shift relative to the view through the window, such that the displayed image may no longer correspond with the outside view. This effect occurs due to movement parallax. In order to maintain the see-thorough illusion of the display, in certain embodiments the displayed image changes to track the driver's position so that the image remains in proper alignment with the window view. Thus, in certain embodiments, the displayed image can at least partially compensate for the effects of parallax.

Advantageously, in certain embodiments, adaptation of the displayed image does not requires tracking of the driver's position. Instead, the display can implement multi-view imaging that shows a correct exterior image regardless of driver position, improving the illusion of transparency. These benefits may be achieved in some embodiments by using a display that simultaneously projects multiple different image perspectives across a defined area, with each perspective becoming visible as the driver shifts his or her position. The different perspectives may be created using a multi-view lens. As the driver moves fore and aft or side to side, the driver's viewing angle relative to the lens changes, enabling the appropriate image to be seen. This arrangement can eliminate or reduce any need for active head or eye tracking and can ensure or attempt to ensure the appropriate exterior image is available independent of the driver's viewing angle relative to the display.

While this solution may be very beneficial for addressing A-pillar vision impairment, the same technique may be applied to any obstruction in any vehicle (including other pillars), which may be a car, truck, boat, airplane, or the like. More generally, the solution described herein can be used to see through or around any obstruction, including walls. For example, it could also be used in stationary applications such as the frames between windows in a building.

### II. Multi-View Display Overview

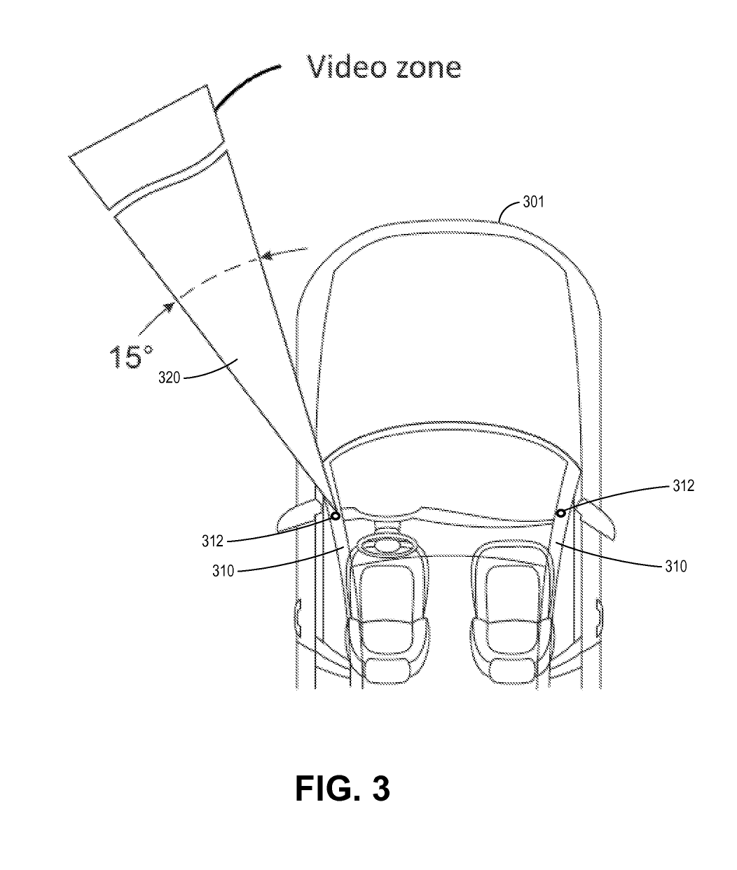

Multi-view lenses in the above-described system can allow multiple two-dimensional or three-dimensional views to be presented across a defined range of positions. A multi-view display incorporating multi-view lenses can receive images from a camera mounted external to a vehicle or internally within a vehicle (such as on a dashboard). An example of such a camera is shown in FIG. 3.

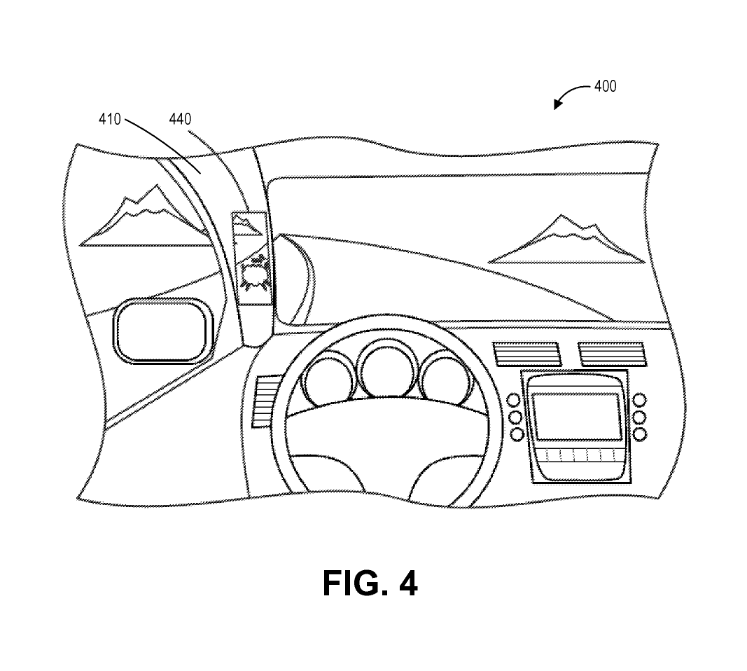

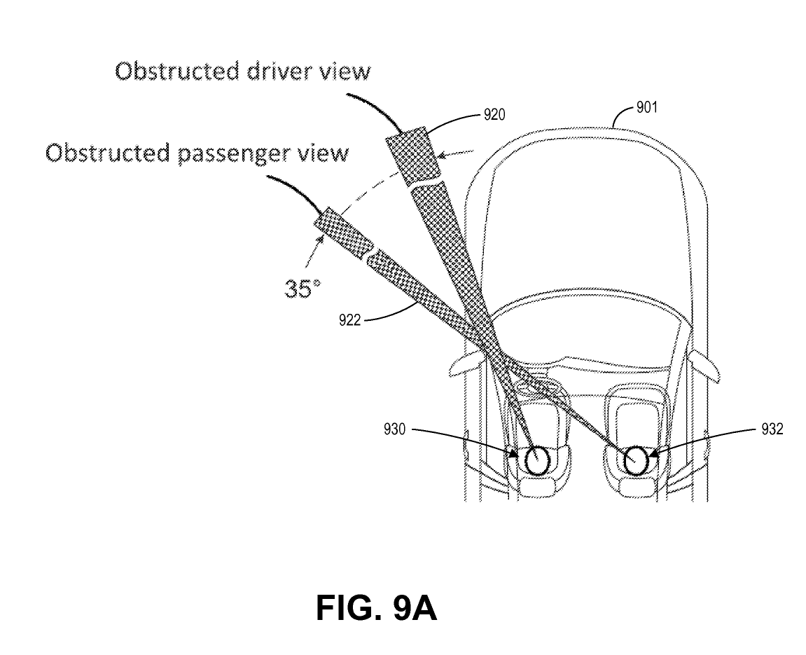

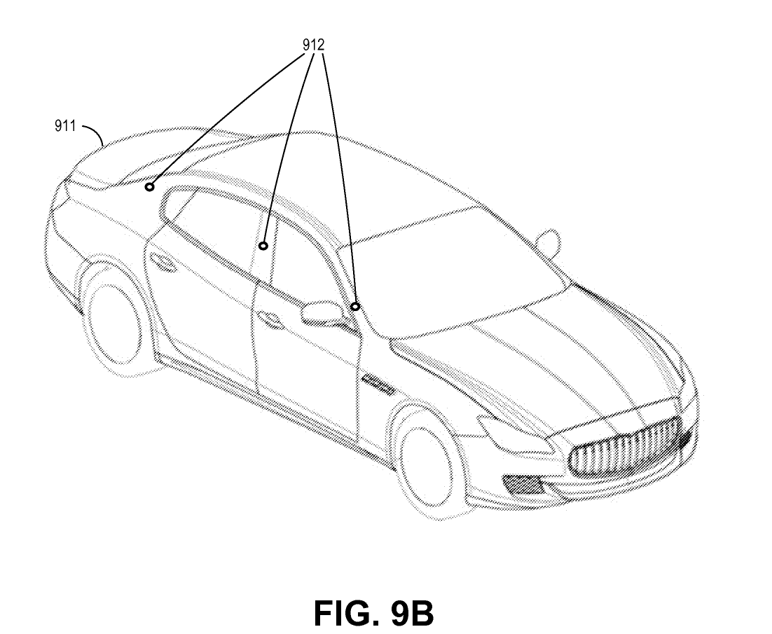

In particular, FIG. 3 depicts an example vehicle 301 with external cameras 312 that can provide a view through pillars 310 of the vehicle. Cameras 312 are shown on two of the pillars 310 of the vehicle, which are A-pillars in the depicted embodiment. Cameras may be placed on other pillars of a vehicle as well as other locations of a vehicle (see for example FIG. 9B). In addition, a single camera 312 may be used on a single pillar, either the driver's side pillar 310 or the passenger side pillar 310. Alternatively, the camera can be internal to the vehicle (such as on a dashboard or behind a review mirror). The image or images obtained by the camera(s) 312 can be displayed on one or more displays in the interior of a vehicle, affixed to the pillar(s) 310. An example of such a display is shown and described below with respect to FIG. 4.

In FIG. 3, one of the cameras 312 is shown capturing video for an example zone of interest 320, which in the depicted example is about 15 degrees in width. A 15 degree zone of interest 320 can capture obstructions or objects that would normally be obstructed by the A-pillar 310. The actual zone of interest 320 range used by the camera 312 may be larger or smaller depending on the specifics of the vehicle in which the system is installed. The zone of interest 320 is shown from the perspective of the forward surface of an A-pillar 310.

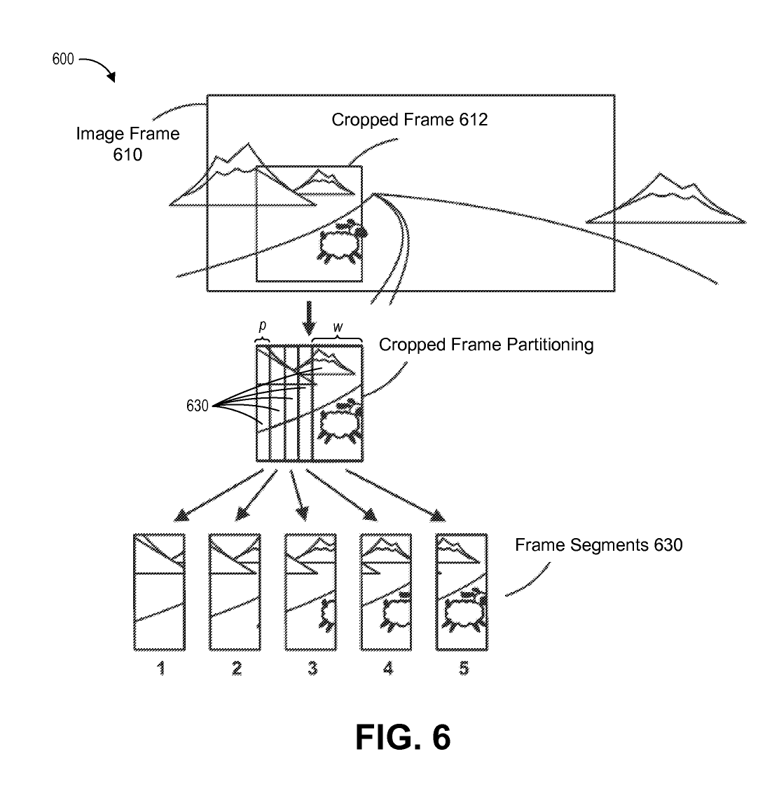

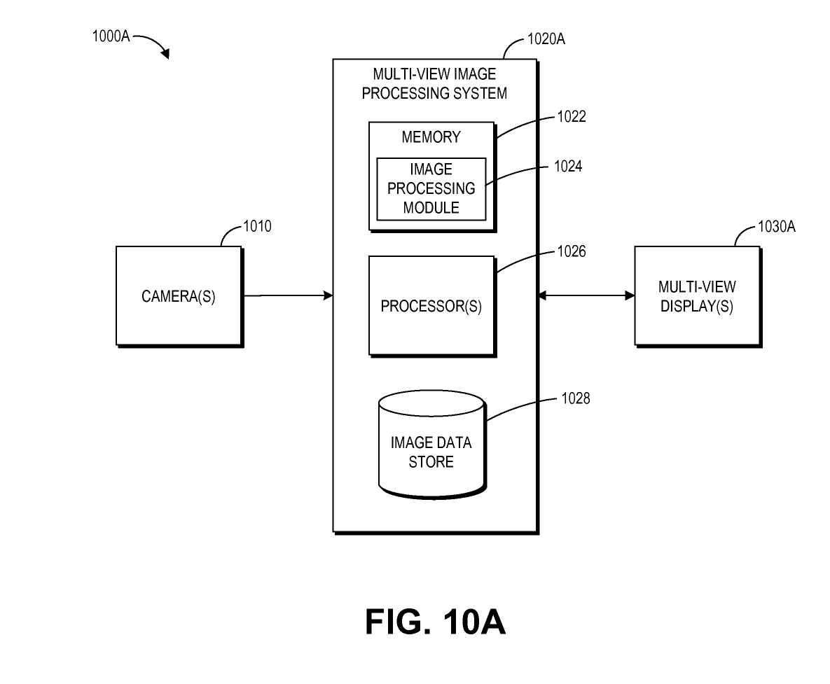

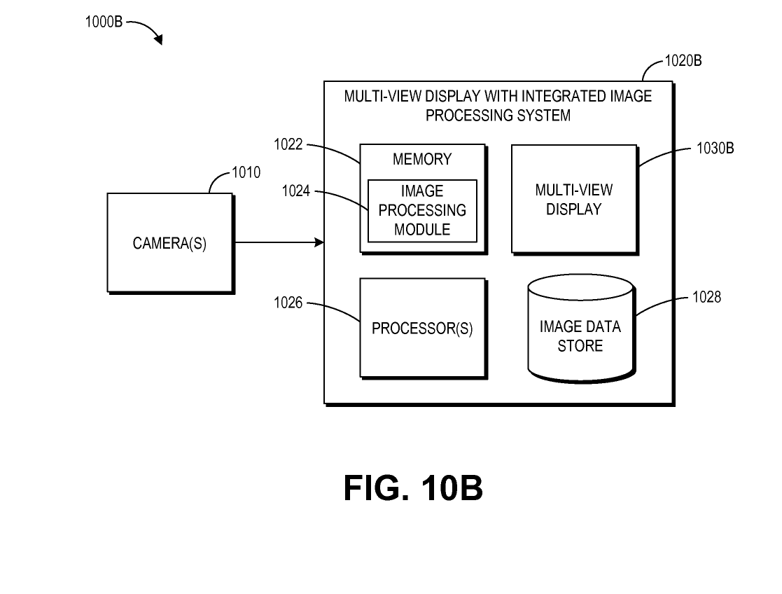

The camera 312 may have a lens with a focal length that captures at least a 15 degree field of view (or larger or smaller in other implementations). However, the actual video zone captured by the camera 312 may be much greater. The desired zone of interest 320 corresponding to the obstructed view by the pillar 310 can be extracted from the full video zone captured by the camera 312. For instance, a multi-view display system described in detail below (see FIGS. 10A and 10B) may include functionality for cropping a wider angle image obtained by the camera 312 down to a smaller video zone, such as the 15 degree video zone 320 shown in FIG. 3. Example features for cropping images are described below with respect to FIG. 6.

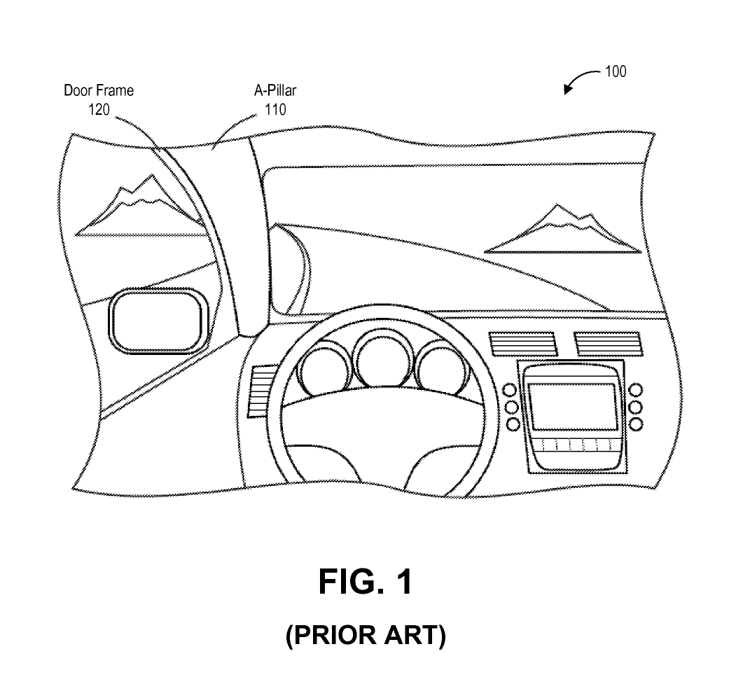

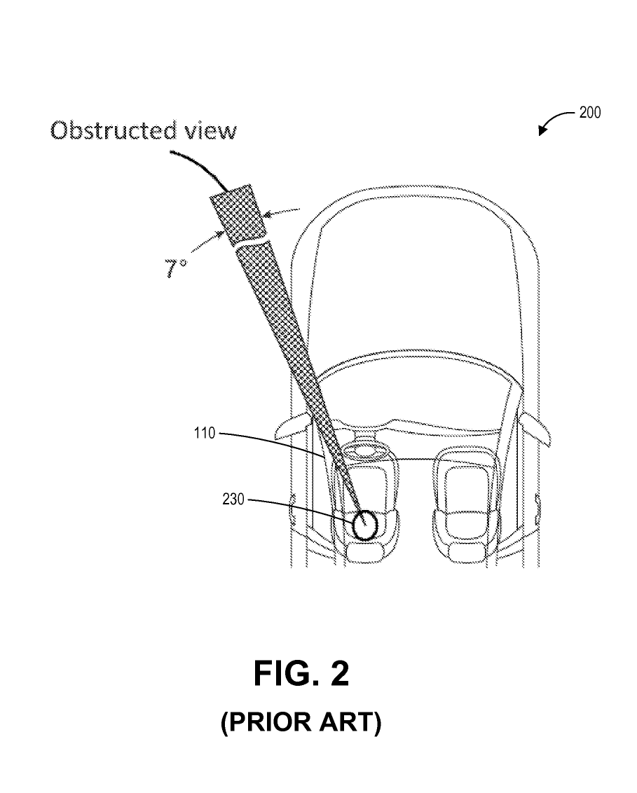

Turning to FIG. 4, a portion of an example interior 400 of the vehicle 301 of FIG. 3 is shown. The interior 400 of the vehicle 301 includes a multi-view display 440 that can provide a view through a pillar 410 of the vehicle 301, such as the pillar 310 shown in FIG. 3. With the multi-view display 440 depicting the video obtained from the camera 312, the driver can see what was previously hidden from view by the A-pillar 310, such as the stray animal depicted in FIG. 4. Comparing the image of the multi-view display of FIG. 4 with the corresponding A-pillar 110 in FIG. 1, one can see that the animal shown in the multi-view display 440 is not shown or is obstructed by the A-pillar 110 in FIG. 1. Thus, the multi-view display 440 can provide greater safety for the driver, enabling the driver to see obstacles more accurately than in the existing art as well as provide greater safety for people and animals that may be obstructed from the driver's view by traditional A-pillars. In addition, the multi-view display 440 can be more accurate than existing multi-view displays that employ head-tracking to determine driver viewing position. Such displays may show the wrong image if a miscalculation of a driver's head position is determined (which may occur, for example, if the driver is wearing a hat, among other situations). In contrast, due at least in part to optical properties of the multi-view display 440, described in detail below, the multi-view display 440 can display the correct image to the driver without having to track the driver's head position. Thus, the multi-view display 440 can provide multiple views without expensive and complex head-tracking algorithms in certain embodiments.

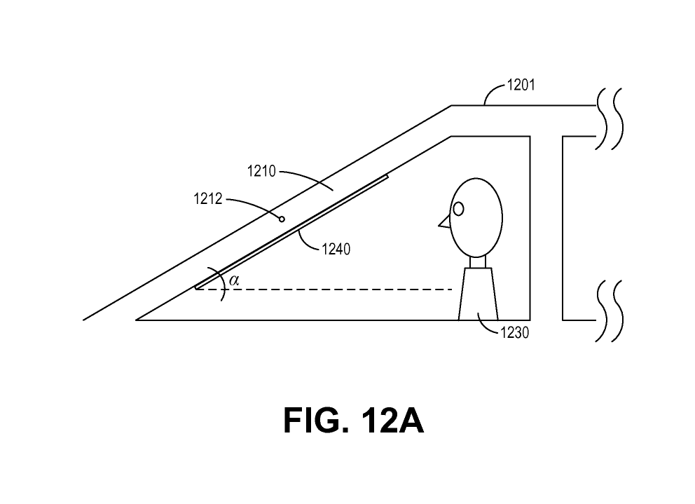

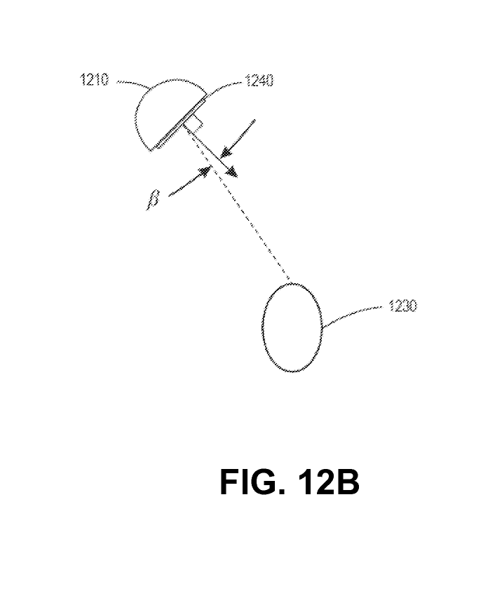

Although shown in a rectangular shape in FIG. 4, the multi-view display 440 may have a shape that conforms more generally to the shape of the A-pillar 410 or to a portion thereof. For example, the multi-view display 440 may be curved to more generally conform to the contour of the pillar. In one embodiment, the lens viewing angle and/or video processing are compensated accordingly to maintain the desired views in a perspective that makes sense to the driver. Example embodiments for such processing are described in detail below with respect to FIGS. 12 through 16.

As described above, if the driver's position changes, for example by moving forward or aft or shifting from side to side, the driver's view of the pillar 410 relative to objects outside the windows will change according to a parallax effect. In the parallax effect, images that are farther away may appear to move more slowly than images closer to the driver as the driver moves position. If a two-dimensional display were used without multi-view capabilities on the A-pillar 410, such a display would not be able to accurately account for parallax in certain situations, and the image may appear in the wrong spot as the driver changes position. Thus, an object may appear to be farther from the front of the vehicle than it really is, resulting in the display not providing sufficient information to the driver to make a decision as to when to stop or slow the vehicle or otherwise maneuver the vehicle to avoid an obstacle or object. Or, an existing display may display what is already visible to the driver through the window, thus failing to display the blocked area of view. The multi-view display 440, in contrast, can reduce the effect of parallax in two dimensional video by including multiple views of the same video that can be viewed by the driver from different angles. The multi-view display 440 can therefore give the appearance of objects behind the A-pillar 410 moving according to the same or similar parallax effect as if looking through the window.

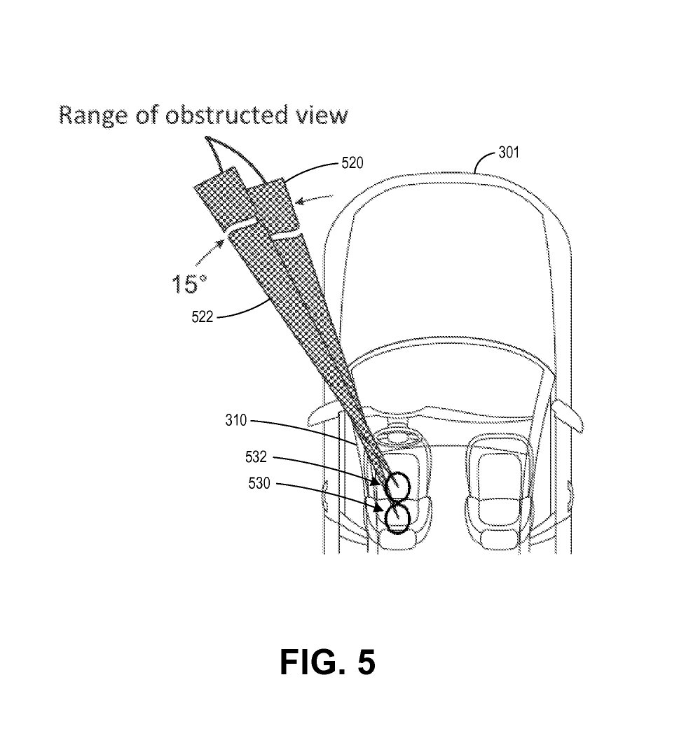

FIG. 5 depicts example ranges 520 and 522 of different views that may be seen on the multi-view display 440 of FIG. 4 based on the positions 530 and 532 of a driver in the vehicle 301. As a driver moves forward from the initial position 530 shown to a position 532, he can see the image differently in the multi-view display. For example, the driver's 530 field of view 520 as seen through the multi-view display at the initial position (530) of the driver differs from the field of view 522 shown when the driver is in the forward position 532.

The field of view blocked by the A-pillar in 310 in the example shown is about 7 degrees. To provide useful coverage of the blocked field of view, in the embodiment shown, the multi-view display 440 can provide a total field of view of about 15 degrees. As described above, the amount of field of view blocked by any particular A-pillar may be other than 7 degrees, and the total amount of field of view provided by a multi-view display may be greater or less than 15 degrees.

In the example of a 15 degree field of view, it may be useful to provide multiple separate views to reduce or avoid the effects of parallax. Fewer or more views can be used in different embodiments. The more views that are used, the greater can be the illusion of transparency provided by the multi-view display. Higher number of views may be preferable so as to improve the seamlessness of the transitions across adjacent images, further improving the effect. Thus two, three, four, or five or more images may be used, although three images may provide a good basic effect.

FIG. 6 depicts an example process 600 for obtaining multiple views for a multi-image display based on a camera image. In FIG. 6, an image frame 610 is shown. The image frame 610 is one frame of several frames that may be captured by a video camera, such as the camera 312 described above. A video is typically composed of numerous image frames, which when shown in succession, provide a motion effect.

The image frame 610 includes a cropped portion of the frame 612 (or “cropped frame 612”). In an embodiment, a multi-view display system (see e.g., FIGS. 10A, 10B) can crop the image to obtain the cropped frame 612 so as to capture a zone of interest behind an obstruction such as an A-pillar. The cropped frame 612 may therefore be smaller than the entire image frame 610 obtained by the camera. For example, the field of view corresponding to the cropped frame 612 can correspond in size to the 15 degree field of view described above (or some other sized field of view). Video editing software (such as Adobe After Effects™) implemented by the multi-view display system can be used to crop the image frame 610. The multi-view display system may provide an initial guess of which subportion of the entire image frame 610 to crop to produce the cropped frame 612. A wireless remote control could be used by a user seated in the driver's or a passenger's seat to shift the camera image into alignment for the driver and/or the passenger. The user may be a vehicle manufacturer or the end-user of the multi-view display system.

In FIG. 6, in the process 600, the cropped frame 612 can be extracted from the image frame 610 and partitioned into multiple overlapping images or frame segments 630. For example purposes, five overlapping images or frame segments 630 are shown, and subsequent FIGURES will use the example of five frame segments 630. However, fewer or more frame segments 630 can be used in other embodiments. The number of frame segments 630 used can correspond to the number of views provided by the multi-view display 440. Each of the frame segments 630 can cover a field of view or width that corresponds to the approximate width of the obstructed view cause by the pillar (e.g., 7 degrees or some other size).

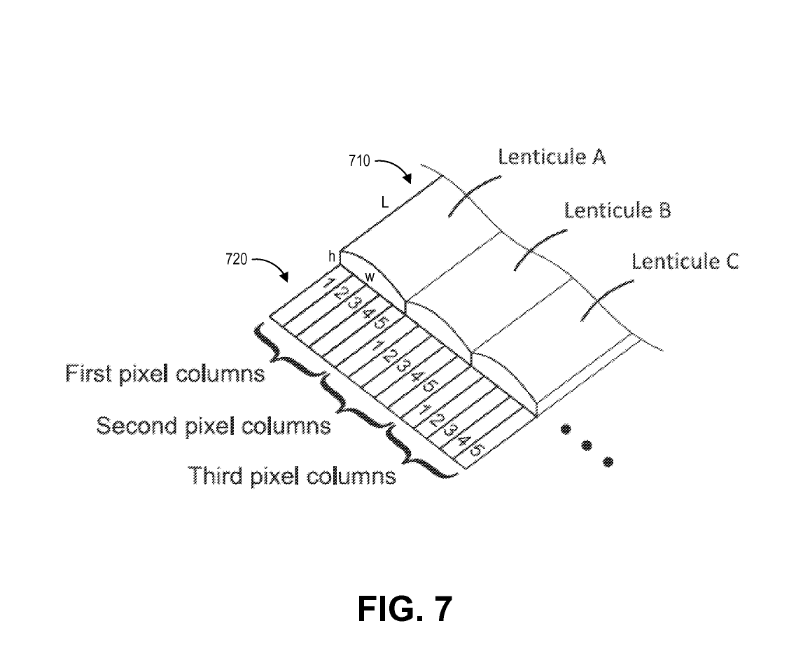

As shown, each of the frame segments 630 has a width w and is offset from other frame segments 630 by an offset width p. Thus, the frame segments 630 numbered one through five in FIG. 6 are each offset from each other by the offset width p, where p<w. When interleaved to produce an interleaved image frame and displayed through a multi-view lens or set of lenses (see e.g., FIG. 7), the interleaved image frame can appear to present multiple views to a vehicle occupant (driver or passenger). Multi-view lenses can be constructed from a particular type of lens called a lenticular lens (sometimes called a cylindrical microlens), a parallax barrier, or from other forms of autostereoscopic display technology, alone or in combination. The remainder of this specification will describe example lenticular multi-view lenses for ease of illustration. However it will be understood that any type of autostereoscopic display technology may be used in place of lenticular lenses to provide a multi-view effect.

For ease of description, many image processing techniques are described herein interchangeably as being implemented on a video or on individual image frames of a video. Thus, it should be understood that operations performed on single image frame may be applied to multiple or all image frames in a video. Such operations may also be performed on a sample of the image frames in a video, such that a subset of less than all image frames may be manipulated according to any of the techniques described herein.

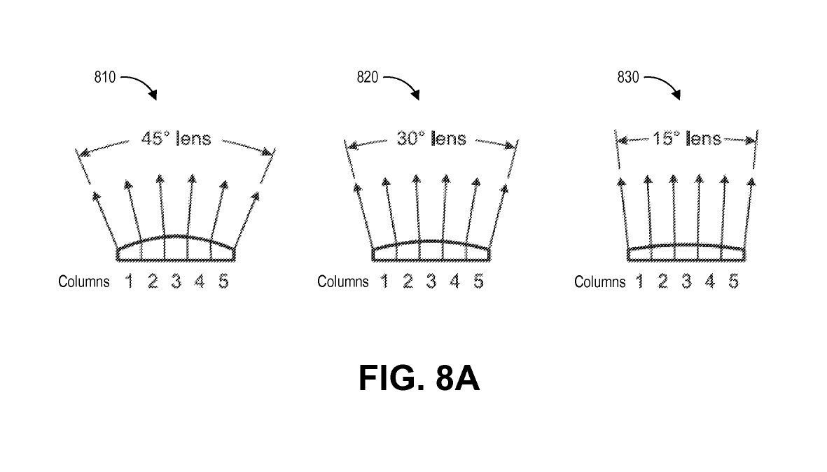

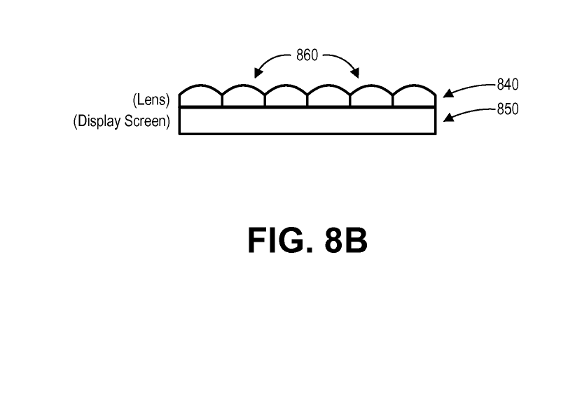

FIGS. 7 through 8B depict portions of example lenticular displays that can be used as the multi-view displays described herein. In particular, FIG. 7 depicts an example close-up perspective view of lenticules 710 of an example lenticular or multi-view display, FIG. 8A depicts example side views of lenticules 810-830 with different viewing angles, and FIG. 8B depicts a side view of lenticules disposed on a display screen.

Referring specifically to FIG. 7, lenticules 710 are shown side by side. Each lenticule is a lens having a height h and a length L. The lenticules 710 are shown only partially in FIG. 7 for illustrative purposes. The length L of each lenticule 710 may extend from the bottom of a display to the top of a display, where the bottom is the portion of the display closest to the vehicle dashboard and the top of the display may be the portion of the display closest to the vehicle roof. The lenticules 710 are shown flush next to each other side by side, although a gap may exist between lenticules in other embodiments. The top surfaces of the lenticules 710 are curved as shown to provide a lens structure. Collectively, the lenticules 710 may be a thin film that is applied as a lenticular lens structure (e.g., with an adhesive backing) on a display screen (see e.g., FIG. 8B).

As described above with respect to FIG. 6, in one embodiment the image frame 610 or the cropped image frame 612 obtained by the camera 312 can be partitioned into multiple frame segments 630, such as five frame segments 630. The frame segments can be interleaved by a processor to be displayed in pixel columns 720 as shown in FIG. 7. Each column of pixels is labeled with a number 1 through 5. The first column 720 of pixels from each of the five frame segments 630 can be displayed side by side underneath the first lenticule 710, shown as lenticule A in FIG. 7. The second column of pixels 720 from each of the frame segments 630 can be placed side by side underneath the second lenticule 710 (lenticule B), and so on under each succeeding lenticule 710. Thus, a column from each frame segment 630 is displayed underneath each lenticule 710 in an embodiment. Since columns of pixels from different frame segments separate columns of pixels from the same frame segment, the columns of pixels can be considered to be interleaved underneath the lenticules. The pixel columns can be interleaved from left to right (or from right to left) across the display until each of the frame segments 630 is fully depicted.

Although for illustration purposes the pixel columns 720 are shown in front of the lenticules 710 in FIG. 7, the pixel columns 720 are actually placed underneath the lenticules 710 so that a viewer may see the pixel columns through the lenticules 710. As the viewer shifts his or her head position relative to the lenticules 710, the display can present one (or more but typically fewer than all) of the columns under each lenticule 710 to the viewer. The particular column of pixels shown underneath each lenticule 710 can depend on the viewing angle of the viewer with respect to the multi-view display. If the viewer is looking directly straight on at the lenticules 710, perpendicularly to the display, the viewer might see column 3 under each of the lenticules 710. If the viewer's head shifts far to the left of the display, the viewer might see each of the “1” pixel columns underneath each of the lenticules 710. Likewise, if the viewer's position shifts all the way to the right, the viewer would likely see column “5” under the lenticules 710, and so on. As the viewer moves his or her head from side to side, the view presented by the lenticules 710 to the viewer can move or progress from one to five (or from five to one depending on which direction the viewer's head is moving), thus presenting to the viewer transitions between different views, compensating for the parallax effect. The multi-view display can thereby ensure or attempt to ensure that the view blocked by the pillar is always presented on the screen.

Since five different frame segments are interleaved under each lenticule in the depicted example, the perceived resolution of the display may be one-fifth of the resolution of the native pixels on a display device. This resolution is a consequence of the basic lenticular technique. However, with sufficient pixel density and sufficiently small lenticules 710, the reduced resolution may be unimportant or not a limiting factor in achieving sufficient resolution for the application. In addition, pixel densities of video screens continue to increase over time, implying the potential for further resolution improvement in vehicle multi-view displays of all types in the future.

The width of the angular view supported by the overall display can be a function of the projection or viewing angle for each lenticule. The lenticules 710 may have any suitable angle or curvature to provide a different viewing angle. For instance, in FIG. 8A, three example side views 810, 820 and 830 of lenticules are shown with different viewing angles. The more convex the lenticule surface, the wider the viewing angle of the overall lenticular lens. The three lenses shown in FIG. 8A have progressively narrower viewing angles as the surface becomes flatter, with the lens 810 having a 45 degree viewing angle, the lens 820 having a 30 degree viewing angle, and the lens 830 having a 15 degree viewing angle. The viewing angle of the lens can provide the viewing angle that is perceived by the viewer. For instance, the 15 degree viewing angle 320 in FIG. 3 can be provided both by cropping of the video appropriately and by providing the degree lens 830 as shown in FIG. 8A.

The lenticules 710 are shown as lenticules 860 in FIG. 8B. The lenticules 860 are disposed side-by-side to form a lens 840. The lens 840 is disposed above the display screen 850. The display screen 850 underneath the lens 840 may be of any display technology such as LED (light emitting diode), LCD (liquid crystal display), OLED (organic LED), AMOLED (active-matrix OLED) or the like and may be flat or curved. A curved display screen 850 may be suitable for conforming to a non-flat surface, such as the surface of a vehicle pillar. A curved display screen 850 may be a flexible display or may instead be a rigid, curved display screen 850. The lens 840 may also be curved. The number of lenticules 860 shown in the lens 840 is small for illustration purposes, and a much larger number of lenticules 860 may be used in an actual multi-view display.

### III. Image Pitch

Besides addressing parallax error due to movement, another aspect of visual perception that can affect the illusion of reality in an in-vehicle display is the sense of depth. In stereoscopic vision, each of our two eyes sees different perspectives of the same object, the degree of difference depending on the distance, with closer objects having the greatest difference. With the multi-view lenses described herein, it is possible for each eye to see a different image, thereby giving a sense of depth.

If a multi-view lens has a low image pitch (e.g., a low density of projected images), there may be certain angles where both eyes will see the same image. The illusion of depth would thus come and go as the viewing position changes, degrading the effect. In order to avoid this, both eyes can be shown different images at most or all times, regardless of viewing angle.

With a typical distance between the eyes of 2.5 inches, and a typical distance to the pillar of about 32 inches for many people, there may be a 4° difference in perspective between the eyes. This is the variable e in the following equation related to image pitch:

Image pitch, I=(e×k), where

e is the parallax angle from the eyes to the display (degrees)

v is the viewing zone of the display (degrees) and

k is the number of views the display presents within angle v.

If the image pitch, I, is greater than 1, each eye will likely see a different image regardless of viewing position, as would happen in real life, thus improving the stereoscopic illusion of looking through a window instead of at an image on the pillar's surface. This effect may be referred to as stereo parallax. For improved long term viewing, large screen 3D TVs tend to have a higher image pitch, with at least 3 times as many images spanning the eyes (I>3), providing more continuous image transitions as the viewer moves.

In contrast to the television example, the video screen in the vehicle pillar application occupies a much smaller portion of the driver's field of vision. Since the display is often seen directly only fleetingly, or with less acute peripheral vision, an image pitch of less than 1 can still achieve the desired result of addressing parallax to a useful degree. Should market demand and manufacturing costs permit, a greater image pitch, e.g. 3 or more, may be appreciated by the end viewer for its more lifelike illusion of transparency. The use of a multi-view display may therefore be capable of reducing one or both of movement parallax and stereo parallax. Thus, the multi-view displays described herein can have any image pitch value above or below or equal to 1.

The example described above with a 15° viewing zone subdivided into 5 views can yield an image pitch of (4°×5 views)/15°=1.3.

### IV. Multiple Viewing Angles and Multiple Cameras

FIG. 9A depicts an example vehicle 901 with a multi-view display (not shown directly in the FIGURE) which can provide views 920, 922 for both a driver 930 and a passenger 932 of the vehicle 901. A larger viewing angle of the multi-view display can enable both the driver 930 and the passenger 932 to experience improved visibility and parallax-compensating benefits of the multi-view display. This benefit can enable the passenger 932 to help spot obstructions or objects that would ordinarily be obstructed by a pillar and help the driver avoid such obstacles. In the depicted embodiment, a single display is adapted to support an expanded zone that serves both the driver and the front seat passenger or even rear seat passengers. As each person may have unique viewing angles relative to the display, each may see their respective images simultaneously although those images may differ. FIG. 9A shows an example situation where, in order to cover both front seat positions, the display zone may span an angle of 35 degrees, as shown by separate display zones 920 and 922 for the driver 930 and passenger 932 respectively. Larger or smaller viewing angles may be provided by the multi-view display in other embodiments.

For ease of description, the specification refers primarily to multi-view displays placed on an A-pillar of a vehicle. However, multi-view displays may be placed on any interior surface, including any pillar of a vehicle. Corresponding cameras may be placed on any external or internal surface of a vehicle to enable capturing of images for such multi-view displays. For example, turning to FIG. 9B, an example vehicle 911 is shown with external cameras 912 on the forward A-pillar, middle B pillar, and rear C pillar of the vehicle 911. If the vehicle were to have an additional pillar in the back (e.g., a D pillar) a camera may be place on such a pillar as well. Corresponding multi-viewed displays may be placed on each of the interior surfaces of those pillars.

More generally, multi-view displays may be placed on any interior vehicle surface as described above, including interior door panels, roofs, floors or even as replacements for windows such as a replacement for a rear window that may not be available in some vehicles. Delivery trucks, for instance, tend not to have rear windows, or if they do the rear window may be obscured by a large cargo area behind the cab of the vehicle. Such trucks tend to have a massive blind spot behind them which could be alleviated by placing one or more cameras on the back of the vehicle and having a multi-view display representing the rear view. This display could be shown behind the driver where such a rear window might typically be provided in another type of vehicle, thus giving the illusion to the driver and/or passenger that they can see out the rear of the vehicle, either by turning their head around or by looking through the rear view mirror.

Other locations for a multi-view display are possible for different types of vehicles. Airplanes, for example, also have many blind spots below or above wings and behind the fuselage, which could be corrected for by any number of cameras and multi-view displays. In yet another embodiment, a single camera may provide images for multiple interior multi-view displays. As shown above with respect to FIG. 6, the actual image frame 610 captured by a given camera, whether external or internal to the vehicle (such as a dashboard camera), may capture quite a bit larger of a field of view than may be desirable to display on a given display. Thus, with respect to FIG. 6 above, it was described that a cropped portion of the frame 612 can be displayed on the interior A-pillar. Remaining portions of the image frame 610 may correspond to other obstructions, such as the obstruction by the B pillar, and may be cropped accordingly and displayed on a separate multi-view display on the B pillar. Alternatively, a camera placed on the B pillar could provide images that may be cropped for the A-pillar and/or the C pillar and so forth.

### V. Example Multi-View Display Systems and Process

FIGS. 10A and 10B depict two example systems 1000A, 1000B for providing multi-view display images in a vehicle. The systems 1000A and 10008 (sometimes collectively referred to herein as the systems 1000) can implement any of the processes described herein, including the process 600 as well as subsequent processes to be described later herein. The system 1000A of FIG. 10A represents an example system that can be installed in a vehicle at the factory where the vehicle is assembled or otherwise by the manufacturer of the vehicle, whereas the system 1000B represents a system that can be installed as an after-market retrofit solution after the vehicle has been manufactured. The system 1000B may also be factory installed in some embodiments.

The systems 1000A and 1000B share certain characteristics. For instance, each system includes one or more cameras 1010 and a multi-view image processing system 1020A or 1020B. The multi-view image processing system 1020A of FIG. 10A includes a memory 1022, one or more processors 1026, and an image data store 1028. The memory 1022 includes an image processing module 1024. The image processing module 1024 can be an application implemented as software and/or firmware that performs any of the processes described herein in whole or in part. The multi-view image processing system 1020A communicates with one or more multi-view displays 1030A. The multi-view display(s) 1030A (and 1030B) may also include one or more image processors or graphics processing units (GPUs).

The multi-view image processing system 1020A may be installed together with an engine computer in the engine of a vehicle at the factory or together with an in-vehicle GPS or navigation system and may share the same processor or processors used in those applications. The multi-view display(s) 1030A is therefore separate from the multi-view image processing system 1020A. In contrast, the system 1020B is an example multi-view display with integrated image processing system. In an after-market retrofit system, it may be more convenient for installation purposes to include the memory 1022, processors 1026, and image data store 1028 together with the display itself 10308 in a single unit that communicates with the one or more cameras 1020.

Thus, in a factory installation of the system 1000A of FIG. 10A it may be possible to take advantage of other electronic systems in the vehicle to improve integration and reduce costs. For example, a vehicle may include significant data storage space for audio files such as music or audible books or maps such as GPS. The vehicle's native computing systems may possess substantial computational resources for GPS navigation or for telemetry of vehicle functions or dynamics such as speed, G-force or crash data gathering. Such computational resources could be shared with the multi-view image processing system 1020A either for real time video brightness tracking control or for applying compensating image distortion effects to the multiple displayed video images.

The storage resources of the image data store 1028 can enable the continuous (or periodic) recording of the cameras 1010 for purposes of forensic analysis after an insurance event, such as a crash or being cited for a moving violation. Images may be stored for an indefinite amount of time or for a most recent period of time, such as the most recent few minutes, to strike a balance between storing data that may be useful for evidence in an insurance event versus storing too much data and requiring a larger data storage unit. The fine tuning of the overall system 1020A, especially the image properties may be more fully exploited in factory installed systems in some embodiments because the system designers may have explicit knowledge of all aspects of the target vehicle's physical characteristics, including the geometry of pillars and the like.

Once the automotive vehicle market experiences successful integration of factory installed systems 1020A, demand may grow for after-market solutions. This demand may present further challenges for successful and safe installation because of the benefit of correctly tailoring the displayed images to the specific geometry of the vehicle. The multi-view display may be placed so as to avoid interference with existing safety devices such as A-pillar airbags. To reduce bulk and weight, the system 1020B may be divided into at least three units, such as the display itself 1030B, the control electronics module including the memory 1022, the processor 1026, and the image data store 1028, and a third unit including the camera(s) 1010. The market or the law may dictate that any such after-market installations be performed by a certified specialist, although this may not be necessary in other embodiments.

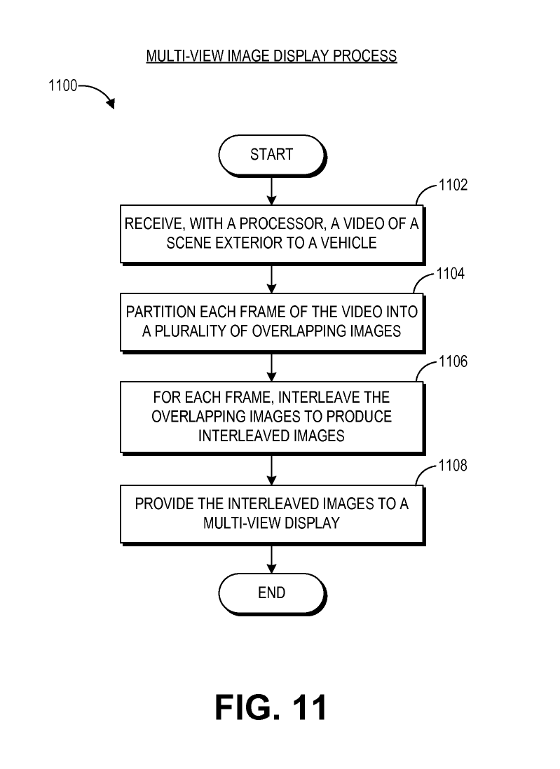

Turning to FIG. 11, an embodiment of a multi-view image display process 1100 is shown. The process 1100 may be implemented by any of the systems described herein, including the systems 1000A and 1000B. Moreover, the multi-view image display process 1100 may be implemented by any system comprising a processor or the like. For convenience, the image display process will be described in the context of the systems 1000 and, in particular, the image processing module 1024.

At block 1102 of the process 1100, the image processing module 1024 receives (via a processor) a video of a scene exterior to a vehicle. At block 1104, the image processing module 1024 partitions each frame of the video into a plurality of overlapping images as described above with respect to FIG. 6. At block 1106, for each frame in the video, the image processing module 1024 can interleave the overlapping images to produce interleaved images. For example, the image processing module 1024 can interleave the frame segments 630 described above to produce the interleaved images. The image processing module 1024 may provide the interleaved images to a multi-view display at block 1108.

### VI. Compensating for Display Placement Distortion

In a typical vehicle, the A-pillar is angled to follow the rake of the windshield. In modern automobiles the windshield rake may be approximately 60 degrees or more from vertical. As a result, the viewer (either driver or passenger) may not be perpendicular to the multi-view display mounted on an interior surface of the pillar.

This situation is illustrated in FIG. 12A, depicting an example side view of a vehicle 1201 with an example multi-view display 1240 mounted to an A-pillar 1210. An external camera 1212 is also mounted on the A-pillar. An occupant of the vehicle, driver 1230, is also shown, although it should be understood that the principles described herein may also apply to a passenger. As shown, the display 1240 is not facing parallel to the driver but rather is at an angle, where the top of the display is closer to the driver than the bottom of the display. The angle of the display 1240 between a horizontal line and the A-pillar 1210 is represented as angle α in FIG. 12A. The occupant 1230 of the vehicle 1201 may perceive the image on the display 1240 to be severely compressed vertically or distorted vertically because the display is not placed flat in front of him, thus preventing a seamless match with the outside view through the adjacent windows. This vertical compression effect may be termed a primary vertical distortion effect due to the vertical positioning of the display 1240. In addition, images appearing closer to the bottom of the display 1240 may appear smaller than images at the top of the screen due to the difference in distance than would otherwise be if the occupant 1230 were viewing the display 1240 straight on. This distortion effect may be termed a secondary vertical distortion effect due to the vertical positioning of the display 1240.

The multi-view display system can compensate for one or both of these distortions. For instance, to address the primary vertical distortion effect, the multi-view display system can stretch the image on the display vertically to increase the length of the image as a function of height on the display. To address the secondary vertical distortion effect, since images toward the bottom of the display may look smaller than they should be were the display 1240 to be shown perpendicular to the horizontal, such images can also be stretched or enlarged more toward the bottom end of the display than the stretching applied to the top end of the display. Thus, images can be progressively stretched larger from the top (with little or no stretching) progressing downward to the bottom (with significant stretching) of the display 1240 to address the secondary vertical distortion effect. The stretching for either the primary or secondary vertical distortion effects may be omitted in other embodiments.

One example process for performing the stretching is as follows. The image on the display can be stretched vertically by a factor of 1/sin(α), where α is the viewing angle to the display in degrees relative to the horizontal. In the case of an example 60 degree viewing angle, the image would be stretched by a factor of 2 using this formula to address the primary vertical distortion effect. The stretch may be applied linearly across the image or it may be advantageous to apply a degree of nonlinearity to compensate for the secondary vertical distortion effect.

Such linear and/or nonlinear stretching of the video image may be achieved using readily available digital image processing techniques, such as a pin corner algorithm. A pin corner algorithm can distort an image by repositioning some or all of its four corners. The pin corner algorithm can stretch, shrink, skew or twist an image to simulate perspective or movement that pivots from the edge. An example implementation of the pin corner algorithm is available in the Adobe® After Effects™ software, which software may be used to perform these adjustments.

The multi-view process, be it implemented by means of a lenticular lens, a parallax barrier, or other forms of autostereoscopic display technology, can intentionally alter the visibility of certain pixels depending on the horizontal angular view to the screen surface as described above. In some embodiments, these techniques do not impair the viewing angle in the vertical direction, making it possible to properly see the image and obtain the multi-view effect when observing the screen from the steep angles anticipated in this automotive application. In other embodiments, it may be useful to further take into account horizontal angle of the display.

In many vehicles, a multi-view display placed on an A-pillar may also be angled horizontally away from a vehicle occupant in addition to being vertically slanted away from the vehicle occupant. FIG. 12B depicts this scenario, with the A-pillar 1210 of FIG. 12 shown angled away horizontally from the vehicle occupant 1230. The display 1240 is affixed to the A-pillar 1210 and is likewise horizontally angled away from the occupant 1230. As a result, images may seem somewhat smaller horizontally than would be the case if the display were viewed straight on axis. The image processing module 1024 may perform a similar horizontal stretching process as was applied to the vertical stretching process described above with respect to FIG. 12B to account for this horizontal distortion. The image processing module 1024 may apply linear and/or nonlinear stretching to compensate for a primary horizontal distortion effect and/or a secondary horizontal distortion effect, analogous to the primary and secondary vertical distortion effects described above. For instance, the image on the display can be stretched horizontally by a factor of 1/cos(β), where β is shown as an angle in FIG. 12B between the perpendicular axis of the display 1240 and viewing axis to the driver 1230. The horizontal stretching may be applied linearly for a narrow display as typical on an A-pillar, or nonlinearly, similar to the vertical stretching described above, with progressively greater stretching at farther distances from the driver.

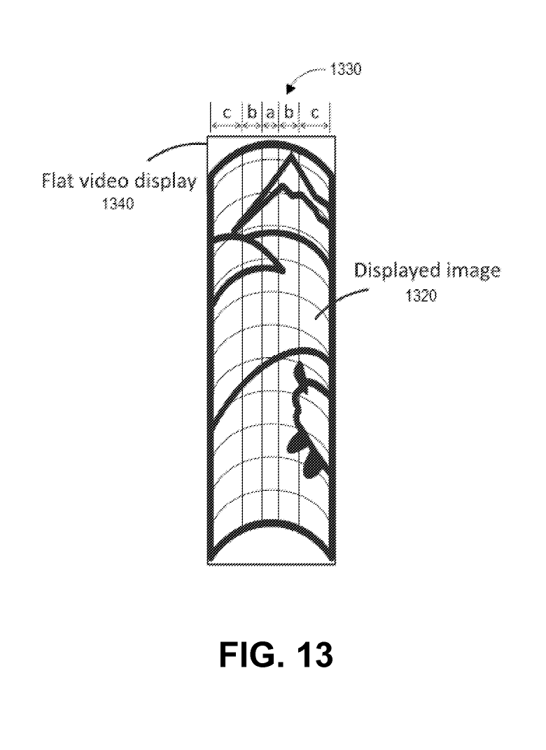

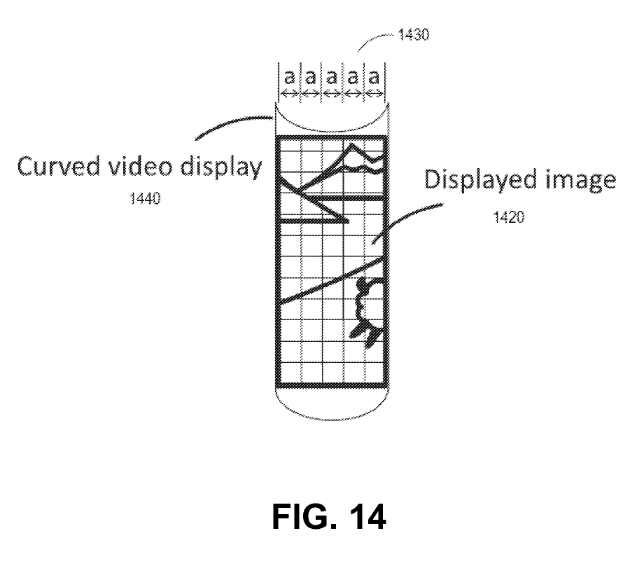

In addition, if the multi-view display is curved to fit the contour of a pillar, such as in the shape of a partial cylinder that many A-pillars exhibit, the image will exhibit a bowing distortion. One or more further forms of digital image compensation can be used to address this. Example versions of these forms of compensation are described with respect to FIGS. 13 and 14.

FIG. 13 depicts an example of a flat multi-view display 1340 as viewed perpendicular to the display surface, with a curved image 1320 displayed thereon. When the flat display 1340 is wrapped onto a pillar of a vehicle, the flat video display 1340 becomes a curved video display, such as the curved video display 1440 shown in FIG. 14. As can be seen, the displayed image 1420 in FIG. 14 does not appear distorted, whereas the displayed image at 1320 in FIG. 13 is distorted. The distortions of the displayed image 1320 are intentionally produced in some embodiments so as to enable the displayed image 1420 in FIG. 14 to have little or no distortion when the display at 1440 is curved on a pillar of a vehicle.

In certain embodiments, the distortions produced in FIG. 13 to enable a left distortion when placed on a curved surface can be performed as follows. First, the image can be progressively stretched horizontally. This stretching process can begin with no stretch applied to the middle of the image or little stretch applied to the middle of the image, indicated by zone ‘a’ in the image 1320 of FIG. 13. The displayed image 1320 in FIG. 13 is divided into a plurality of columns 1330 or zones having widths labeled ‘a’, ‘b’, and ‘c’. The degree of stretch in FIG. 13 can increase progressively as one moves outward from the center column having width ‘a’ towards the exterior columns having width ‘c’. This linear or non-linear horizontal scaling can compensate for the squashing effect that may occur more pronouncedly toward the edges of the display 1340. As the squashing caused by the curvature of the display 1340 increases continuously in some cases, the compensating correction may also increase continuously or approximately continuously over the display, increasing from the center column with width ‘a’ to the columns of width ‘b’ and still further in the columns of width ‘c’. Each of the columns 1330 may have the same perceived width by a viewer of corresponding columns 1430 of width ‘a’ in the curved displayed image 1420 of FIG. 14.

Another form of video processing can also be used to compensate for the bowing effect. This form of video processing can include applying a bow to the image in the opposite direction of the bow created by the curvature of the pillar, again using existing available image processing techniques. Example techniques that can be used to produce a bow opposite to the direction of the natural bow of the display on a curved surface include a bezier warp effect. In the bezier warp effect, the positions of the vertices and tangents determine the size and shape of a curved segment. Dragging these points can reshape the curves that form the edge, thus distorting the image. The bezier warp can be used to bend the image to achieve an undistorted look. The bezier warp effect can also be implemented by Adobe™ After Effects™ software. Thus, FIG. 13 shows how the displayed image 1320 is bowed and stretched non-linearly along the horizontal axis and also stretched either linearly or non-linearly along the vertical axis to compensate for the vertical break of the pillar, described above with respect to FIG. 12A. Bowing may be applied after horizontal stretching or before horizontal stretching. In another embodiment, one of the bowing and stretching techniques are used but not the other.

FIG. 14 shows an example of final results from the driver's perspective once the display of FIG. 13 is angled forward to match the break of the pillar and curved to wrap around the pillar, producing a natural undistorted view of the outside scene. The displayed image 1420 in FIG. 14 is shown without any distortion, although in some embodiments some distortion may still be present. The distortion may be reduced from the distortion that may be perceived without applying one or more of the image processing techniques described herein.

The previous discussion considers that the multi-view display is both angled vertically and/or horizontally and curved. It is also possible that the display panel may remain flat, angled forward to match the break of the pillar as before. Many video display panels have limited viewing angles. For instance, many LCD displays are normally intended to be viewed along an axis perpendicular to the display surface. Off axis, as viewers are angled away from the screen, the screen may appear darkened or with poorer color balance to viewers.

It may be useful in some embodiments for the multi-view display to maintain good image quality characteristics, such as brightness and color balance, from off-axis viewing angles as may occur in vehicle applications. At off-axis viewing angles, some displayed technologies perform better than others, showing greater brightness and color accuracy as the viewing angle decreases from 90°, whereas other types of display technologies darken and/or become less visible as the display is angled from 90°. For reasons of cost, durability or safety, such as glass versus plastic surfaces, the first choice for an application may not have the ideal image properties. Thus, although it may be beneficial in some embodiments to use an OLED display with good or excellent off axis viewing properties, such a display may be prohibitively cost expense. Thus, other avenues may be used to produce better off-axis access viewing properties.

The use of the multi-view display in a vehicle is unusual in that in a typical application on a pillar, the display may be seen primarily from an off-axis perspective. In order to achieve an accurate presentation of the outside view of the blind spot, the display's brightness capability and color balance can be beneficial performance factors to achieve the desired end result. Just as a lenticular lens or other type of multi-view display may selectively focus certain areas of the video image to a certain view along the horizontal axis, so too may a multi-view lens be applied to refocus on a vertical axis. It is therefore possible that the image properties can be redirected to optimize or otherwise improve the off-axis viewing properties of the image over the driver's relatively narrow vertical viewing zone.

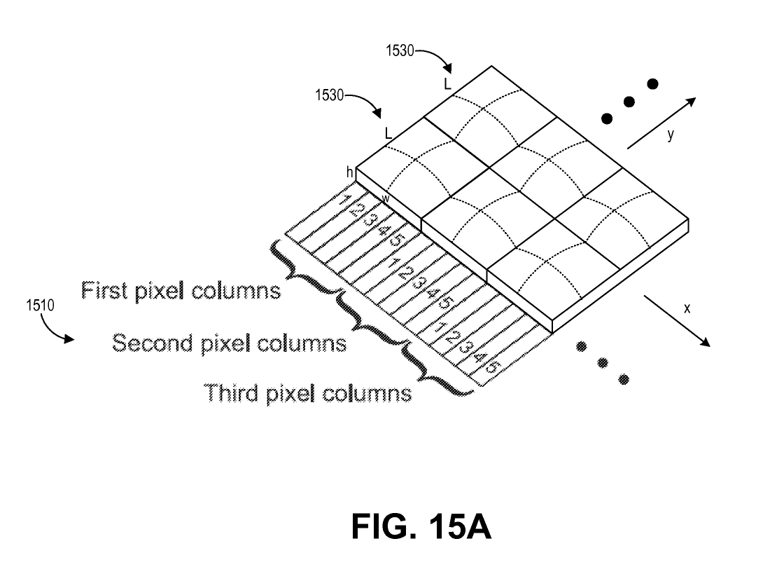

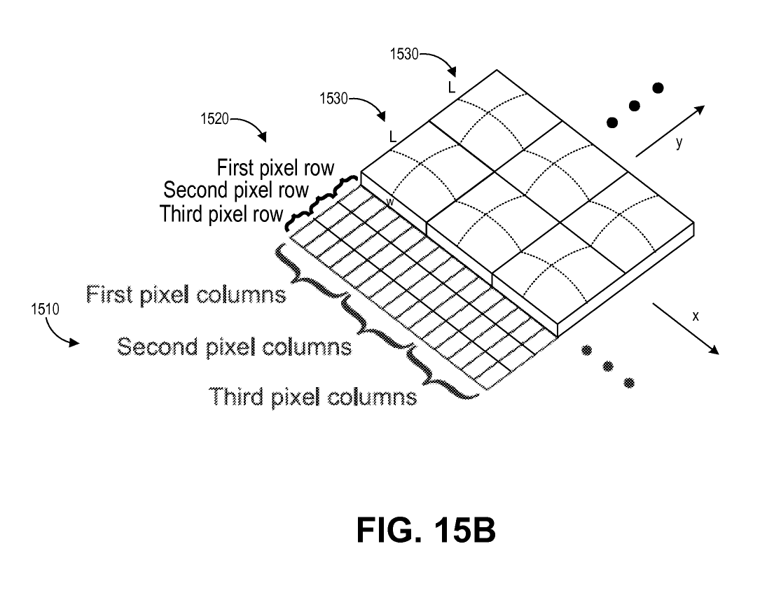

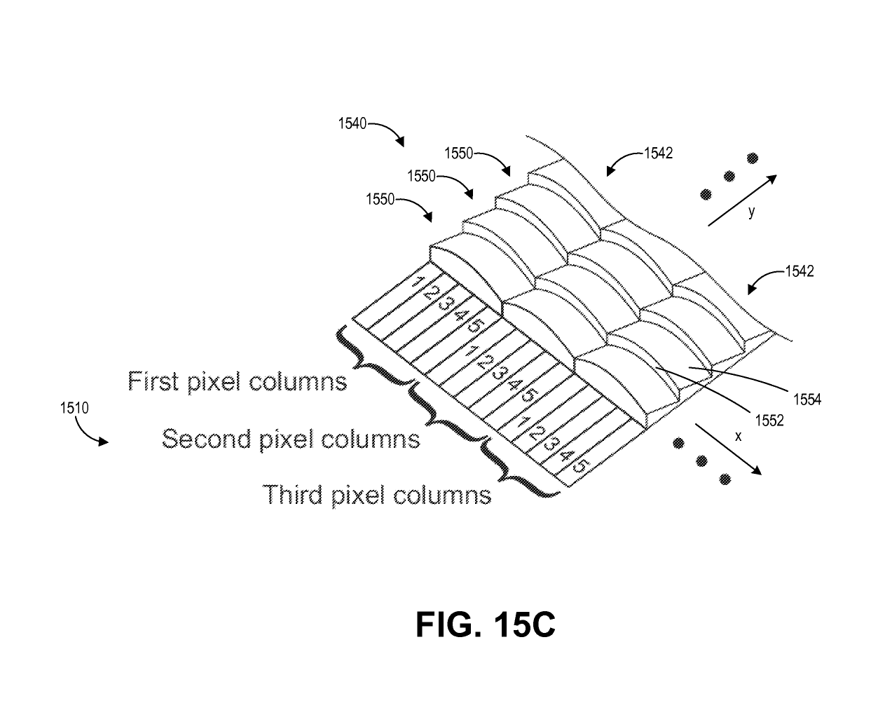

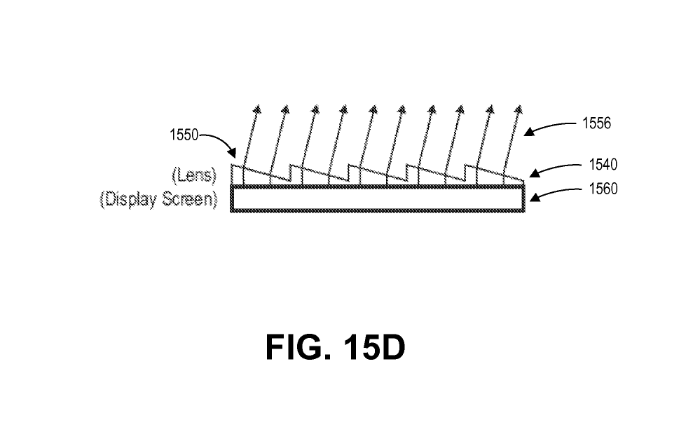

For example, referring to FIG. 15A, another embodiment of a multi-view display is shown with a fly's eye lens 1530 that includes magnification in a horizontal direction as in FIG. 7, as well as magnification in a vertical direction. This horizontal and vertical magnification is provided by curved surfaces in both the horizontal and vertical directions. The horizontal direction is indicated by arrow “x” and the vertical direction is indicated by arrow “y” in FIG. 15A. The fly's eye lens 1530 may also be considered a microlens array in an embodiment. The surfaces of the fly's eye lens 1530 can be spherical, having the same magnification power in both horizontal and vertical directions, or anamorphic, having different optical power in the vertical and horizontal directions. Optical power may, for instance, be higher in the horizontal direction to provide for more reviews in the horizontal direction than in the vertical direction. Fewer views in the vertical direction may be acceptable because a vehicle occupant's head tends to move more in the horizontal direction than in the vertical direction.

Pixel columns 1510, like the pixel columns 720 of FIG. 7, are also shown. Like the structure shown in FIG. 7, the micro lens array of fly's eye lenses 1530 can be superimposed above a display screen with interleaved pixel columns 1510 (see, e.g., FIG. 8B). The magnification of the lenses 1530 in the vertical direction can redirect the image vertically so as to compensate in some embodiments for poor off-axis viewing angles. Thus, where the display is placed upon a pillar that is vertically slanted away from the driver, the driver may perceive little to no reduction in brightness and color balance by virtue of the vertical magnification of the lens 1530. Thus, in certain embodiments, the functions of an altered vertical directivity and horizontal multi-view capability may be combined into a single compound lens structure.

The horizontal/vertical directivity lens and the associated video processing may also support multi-view capabilities so that adaptation of the driver height is likewise automatically addressed, similarly as is done in the horizontal direction. As an example, referring to FIG. 15B, a microlens array or fly's eye lens 1530 is again shown as well as pixel columns 1510. Pixel rows 1520 are also shown, which may include interleaved rows of pixels similar to the interleaved columns 1510 of pixels described above. The interleaving of pixel rows 1520 may be accomplished in a similar manner to the processes of FIG. 6 and FIG. 11 described above, and they may provide for multiple views to compensate for parallax in the vertical direction. Thus, when a driver moves up and down relative to the driver's seated position, the image may exhibit the appropriate amount of movement to appear as if it is tracking the actual image that is being obtained by the camera.

The number of vertical views used may be fewer than in the horizontal direction since the driver's height may vary less than in the horizontal direction. Alternatively, the number of rows 1520 used to create the views may be the same as or even more than the number of pixel columns 1510 used to compensate in a horizontal direction. Advantageously, in certain embodiments, the micro lens array described with respect to FIG. 15B may also compensate for parallax effects from diagonal movement of the viewer's head as well.

If the vertical axis of the display is limited to a single view, the vertical axis may be redirected with a linear Fresnel lens which has no magnification in the vertical axis to compensate for poor brightness or color balance in off-axis viewing angles. As an example, FIG. 15C depicts a perspective view of an example microlens array 1540 having a partial Fresnel lens structure. The microlens array 1540 includes compound lenses having lenticular lenses 1542 in columns along a y-axis and Fresnel lenses 1550 in rows along a x-axis. The lenticular lenses 1542 can provide the same benefits of the lenticular lenses 710 described above. The Fresnel lenses 1550 include ridges 1552 and sloped surfaces 1554, which refract light. As a result, the Fresnel lenses 1550 redirect light from the display vertically, which can at least partially compensate for poor brightness or color balance in off-axis viewing angles. FIG. 15D depicts a side view of the example microlens array 1540 of FIG. 15C having Fresnel lenses 1550 (with lenticular shape not shown) disposed over a display screen 1560. Unlike the view shown in FIG. 8B (which is seen from the y-axis), the axis coming out of the page in FIG. 15D is the x-axis of FIG. 15C. Light, represented as rays 1556, is shown refracted by the Fresnel lenses 1550. Thus, if the display shown in FIG. 15D were oriented vertically, the light rays 1556 would be redirected upward, thereby helping to compensate for the poor off-axis viewing angles described above.

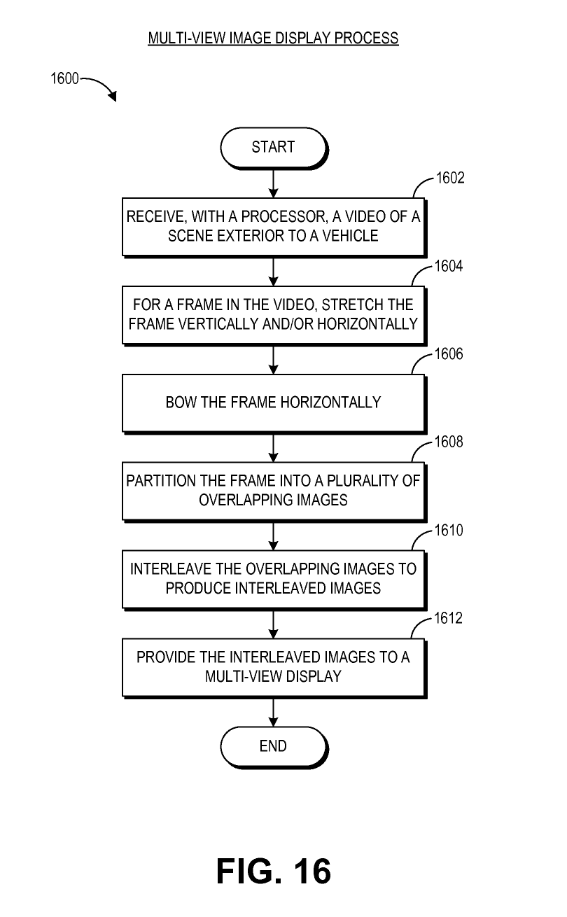

Tying the concepts of FIGS. 12A through 15D together, FIG. 16 depicts an example multi-view image display process 1600. The process 1600 can be implemented by any of the systems described herein, including the systems 1000. For instance, the image processing module 1024 can implement the features of the process 1600. Other systems not described herein may also implement the process 1600.

At block 1602, the image processing module 1024 receives a video of a scene exterior to a vehicle. For a frame in the video, at block 1604, the image processing module 1024 can stretch the frame vertically and/or horizontally. Stretching vertically can be used to compensate for the vertical distortions of the pillar as it follows the windshield, and horizontal stretching can be used to compensate for the angle of the pillar away from the viewer, as described above with respect to FIG. 12B, as well as for wrap-around effects due to curving of the display, as described above with respect to FIGS. 13 and 14.

At block 1606, the image processing module 1024 can bow the frame horizontally, as described above with respect to FIGS. 13 and 14. The image processing module 1024 can partition the frame into a plurality of overlapping images or frame segments of block 1608, such as are described above with respect to FIGS. 6 and 11, as well as in the vertical direction, such as described above with respect to FIG. 15B. The image processing module 1024 can interleave the overlapping images at block 1610 to produce interleaved images and provide the interleaved images to a multi-view display at block 1612. The multi-view display can include a lenticular or a horizontal multi-view structure or may also include vertical multi-view structures such as in FIG. 15B.

### VII. Example Multi-View Display User Interface

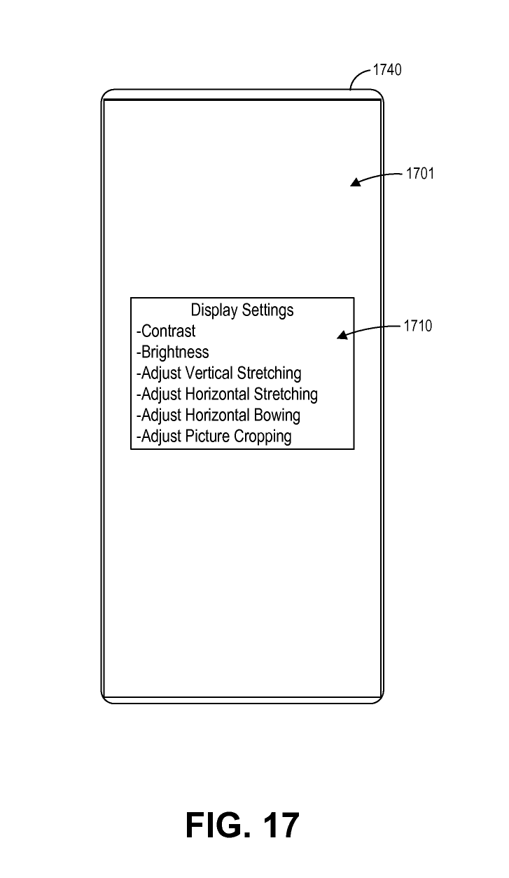

Turning to FIG. 17, an example multi-view display 1740 is shown with a user interface 1701. The multi-view display 1740 may be a touchscreen or the like. In the user interface 1701, display settings 1710 are shown that can enable a viewer to adjust the display settings of the multi-view display 1740. Example display settings 1710 shown include settings for contrast, brightness, adjusting vertical stretching, adjusting horizontal stretching, adjusting horizontal bowing, and adjusting picture cropping. Settings such as the ones shown may be provided, for example, in after-market solutions (or even factory installed systems) where the multi-view display 1740 may be placed in any number of different types of vehicles. The settings shown or other settings can therefore provide flexibility in enabling the multi-view display 1740 to be used in different vehicles. The settings can enable the viewer to fine-tune the characteristics of the multi-view display to reduce distortion and match an appropriate multi-view effect to the viewer's particular vehicle configuration, seat position, and/or driver size. Settings may also be used and provided for factory-installed multi-view displays.

Other settings may be provided which are not shown, and fewer than all of the settings shown may be used in other embodiments. The adjustment of vertical stretching and horizontal stretching and bowing may be used to compensate for the effects described above with respect to FIGS. 12 to 16. The adjusting of picture cropping may be used, as discussed above with respect to FIG. 6, to select the cropped frame 612 out of the image frame 610.

### VIII. Terminology

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a hardware processor, which may include a general purpose processor, a digital signal processor (DSP), an application specific integrated circuit (ASIC), a field programmable gate array (FPGA) or other programmable logic device, discrete gate or transistor logic, discrete hardware components, digital logic circuitry, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Disjunctive language such as the phrase “at least one of X, Y and Z,” unless specifically stated otherwise, is to be understood with the context as used in general to convey that an item, term, etc. may be either X, Y, or Z, or a combination thereof. Thus, such conjunctive language is not generally intended to imply that certain embodiments require at least one of X, at least one of Y and at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A system for increasing visibility in a vehicle, the system comprising:
a camera configured to obtain video of a scene exterior to a vehicle, the scene at least partially blocked by a pillar in the vehicle so as to create a blind spot in the vehicle;
a multi-view display configured to be affixed to an interior portion of the vehicle pillar, the multi-view display comprising:
a display screen, and
a multi-view lens disposed on the display screen; and
a hardware processor in communication with the camera and with the multi-view display, the hardware processor configured to implement an image processing module configured to:
receive the video of the scene exterior to the vehicle, the video comprising a plurality of video frames,
partition each of the video frames into a plurality of overlapping images;
interleave the overlapping images to produce an interleaved image frame corresponding to each of the video frames; and
provide the interleaved image frame corresponding to each of the video frames to the multi-view display;
wherein the multi-view display is configured to receive the interleaved image frame from the hardware processor and to output the interleaved image frame such that a different one of the overlapping images is presented to an occupant of the vehicle based on a position of the vehicle occupant with respect to the multi-view display.

2. The system of claim 1, wherein the multi-view lens comprises a lenticular lens.

3. The system of claim 1, wherein the multi-view lens comprises a parallax barrier.

4. The system of claim 1, wherein the multi-view lens comprises a fly's lens array.

5. The system of claim 1, wherein the hardware processor is further configured to perform one or more of the following image enhancements on the video frames: bowing, horizontal stretching, and vertical stretching.

6. An apparatus for increasing visibility in a vehicle, the apparatus comprising:
a hardware processor configured to:
receive a video of a scene exterior to a vehicle from a camera, partition the video into a plurality of overlapping images, and
interleave the overlapping images to produce interleaved images; and
a multi-view display configured to receive the interleaved images from the hardware processor and to output each of the interleaved images such that a different one of the interleaved images is presented to an occupant of the vehicle based on a position of the vehicle occupant with respect to the multi-view display.

7. The apparatus of claim 6, wherein the multi-view lens comprises a lenticular lens.

8. The apparatus of claim 7, wherein the multi-view lens comprises a compound lenticular lens and Fresnel lens.

9. The apparatus of claim 6, wherein the multi-view lens comprises a microlens array.

10. The apparatus of claim 6, wherein the multi-view display and the hardware processor are integrated in a single unit.

11. The apparatus of claim 6, further comprising a data storage device configured to store images of the multi-view video for subsequent provision to an insurance entity.

12. A method of increasing visibility in a vehicle, the method comprising:
receiving, with a hardware processor in a vehicle, a video of a scene external to the vehicle, the scene obstructed at least partially from view from an interior of the vehicle by a pillar of the vehicle;
generating a multi-view video from the video of the scene with the hardware processor, the multi-view video comprising interleaved images of the scene; and
electronically providing the multi-view video from the hardware processor to a multi-view display affixed to the pillar in the interior of the vehicle, enabling the multi-view display to present a different one of the interleaved images of the scene to the driver depending on a viewing angle of the driver with respect to the multi-view display.

13. The method of claim 12, wherein said generating the multi-view video comprises generating horizontally-interleaved images.

14. The method of claim 12, wherein said generating the multi-view video comprises generating vertically-interleaved images.

15. The method of claim 12, wherein said generating the multi-view video comprises generating both horizontally-interleaved and vertically-interleaved images.

16. The method of claim 12, wherein said generating the multi-view video comprises one or both of stretching the video horizontally or stretching the video vertically.

17. The method of claim 12, wherein said generating the multi-view video comprises bowing the video.

18. The method of claim 12, further comprising providing one or more viewer interface controls configured to provide functionality for a viewer to adjust a crop of the multi-view video.

19. The method of claim 19, wherein the one or more viewer interface controls are further configured to provide functionality for the viewer to adjust a bowing parameter of the multi-view video.

20. The method of claim 12, further comprising storing images from the multi-view video for subsequent provision to an insurance entity.

21. A method of increasing visibility in a vehicle, the method comprising:
obtaining a multi-view video of a scene external to a vehicle, the scene obstructed at least partially from view from an interior of the vehicle by a pillar of the vehicle, the multi-view video comprising interleaved images of the scene; and
electronically outputting the multi-view video on a multi-view display affixed to the pillar in the interior of the vehicle so as to present a different one of the interleaved images of the scene to an occupant of the vehicle depending on a position of the vehicle occupant with respect to the multi-view display.

22. The method of claim 21, wherein said obtaining and said electronically outputting are performed by a hardware processor separate from the multi-view display.

23. The method of claim 21, wherein said obtaining and said electronically outputting are performed by the multi-view display.
